(19) United States
(12) Patent Application Publication
(10) Pub. No.: US 2008/0288489 A1
(43) Pub. Date: Nov. 20, 2008

(54) Method for Searching Patent Document by Applying Degree of Similarity and System Thereof

(76) Inventor: Jeong-Jin Kim, Seoul (KR)

Correspondence Address: Jefferson IP Law, LLP, 1730 M Street, NW, Suite 807, Washington, DC, 20036, US

(21) Appl. No.: 12/090,480

(22) PCT Filed: Aug. 9, 2006
(86) PCT No.: PCT/KR2006/003125

§ 371 Date: Apr. 16, 2008

(30) Foreign Application Priority Data
Nov. 2, 2005 (KR) 10-2005-0104402

(51) Int. Cl. G06F 17/30

(52) U.S. Cl. 707/6; 707/E17.015

(57) ABSTRACT

A method for searching patent documents by applying degree of similarity and a system thereof are disclosed. The method for searching patent documents by applying degree of similarity comprises receiving at least one search keyword from a user of the service; searching a document previously stored in a database, by the search keyword; and evaluating a degree of similarity to the search keyword on the document that is searched by the search keyword, wherein the degree of similarity is evaluated by measuring at least one degree among a degree of appearance frequency of the search keyword in the document, a degree of proximity between the search keywords, and a degree of word order between the search keywords. Therefore, patent documents may be searched by arranging the documents according to a degree of similarity to a search keyword, and not according to whether the keyword is included in the patent documents.

### TECHNICAL FIELD

The present invention relates to a method for searching patent documents by applying degree of similarity and a system thereof. More particularly, the present invention relates to a method for searching patent documents and a system thereof according to an order of degree of similarity that is measured with a weight, for example, appearance frequency, proximity and word order of a search keyword in a patent document search service.

### BACKGROUND ART

Nowadays, guarantee of intellectual property rights is deeply related to competitiveness of enterprises. Disputes of patent rights may often occur when new products are developed with ignorance of previous patent rights.

That is, comprehensive patent strategies related to prospective products are required for the enterprises to survive, and commonly include patent wars. For example, stronger measures, such as prevention of patent disputes, pursuance of sole development of core technologies, and reduction of royalties through patent-evasion design, are required.

In order to satisfy the above requirements, a thorough analysis of intellectual property rights of the related technology and a determination of the direction of technology development are needed first. For example, an analysis of whether original patent rights exist or not, evasion probability of the original patent right, and technology development trends of competitors may be needed.

Thus, a search for previous intellectual property rights, i.e., previous patents, is required so as to check whether the previous patents exist or not.

However, it is difficult to obtain detailed information on previous patents from search engines for general documents, since patent documents containing contents related to previous patents have unique properties different from general documents. Thus, searches on Internet sites that are specialized in searching for patent documents are used for detailed searches for contents of patent laid-open publications, such as application dates, applicants, issue status, and so on.

According to a conventional method of searching for previous patents, a search engine user inputs a search keyword to search the previous patents after connecting to an Internet site (for example, http://www.kipris.or.kr or http://www.wips.co.kr) that provides a patent search service. Then, previous patents related to the search keyword among the patent laid-open publications are searched so that the user may check the contents of the desired patents, such as brief information, main drawings, etc.

FIG. 1 is a screen view illustrating search results from a conventional patent search service site (http://www.kipris.or.kr).

When a user inputs a keyword related to a patent document for searching, a list of the searched patent documents is arranged on a screen as illustrated in FIG. 1. Herein, the user may select the arrangements of the list so that the searched patent documents are arranged in order of application number, issue status, filing date, title of the invention, etc.

However, the above list of the searched patent documents contains nothing but application numbers, filing dates, titles of the inventions, etc., which are sorted in an ascending or descending alphabetical or numerical order. Thus, there are limits to arranging the searched patent documents in order of similarity of the contents to the desired keyword. Therefore, it is inconvenient to click every list and check the contents one by one so as to find the most similar patent document to the desired document among the searched patent documents.

That is, since the searched patent documents are arranged by formal standards and not a degree of similarity to the contents, the search service is not efficient, and thus causes inconvenience and much time is required for searching patent documents. The more patent documents related to the keyword are returned in the search, the more effort is required and inconvenience is caused, which cause problems of increasing costs and lagging technical competitiveness in patent wars.

FIG. 2 is a screen view illustrating search results from a conventional patent search service site (http://www.wips.co.kr).

As in the site http://www.kipris.or.kr illustrated in FIG. 1, a list of the related patent documents is shown on a screen as illustrated in FIG. 2 when a keyword is inputted at the site http://www.wips.co.kr. However, the search service site (http://www.wips.co.kr) also does not show the list according to the degree of similarity but arranges the searched patent documents based on formal items, such as country, patent number or title of the invention.

As described above, in a conventional patent search service, patent documents are arranged not according to similarity of contents but formal items. Thus, there are problems of inconvenience and waste of time and costs, since a user may have to check the whole list one by one so as to find the most similar patent document.

In addition, it is difficult for inexperienced users to make a judgment on which previous patent is suitable for the desired information only with a list of the search results. Thus, the more the previous patents are searched, the longer time it takes to find suitable previous patents.

Of course, there are some Internet sites (for example, http://www.naver.com) providing a search service having a function of arranging general documents in order of degree of similarity, but not for patent documents. However, there are problems in that standards for evaluating the degree of similarity are not subdivided, and users may not be able to set up the evaluation standards for the degree of similarity so as to match individual tastes.

### DISCLOSURE OF THE INVENTION

### Technical Problem

The present invention provides a patent document searching method and a system thereof for searching patent documents more quickly and easily by arranging the patent documents according to a degree of similarity to a search keyword, and not according to whether the keyword is included in the patent documents or not, in a search for patent documents.

The present invention also provides a general document searching method and a system thereof for searching general documents more accurately and reliably by subdividing standards for evaluating the degree of similarity and setting up the standards so as to match a user's tastes.

### Technical Solution

Accordingly, the present invention is provided to substantially obviate one or more problems due to limitations and disadvantages of the related art.

Example embodiments of the present invention may provide a method of providing a patent document search service by applying degree of similarity.

Example embodiments of the present invention may also provide a method of providing a general document search service by applying degree of similarity.

Example embodiments of the present invention may also provide a system for providing a document search service by applying degree of similarity.

Example embodiments of the present invention may also provide a processor for providing a document search service by applying degree of similarity.

In some embodiments of the present invention, a method of providing a patent document search service by applying degree of similarity includes: (a) receiving at least one search keyword from a user of the service; (b) searching a patent document previously stored in a database, by the search keyword; and (c) evaluating a degree of similarity to the search keyword on the patent document that is searched by the search keyword, wherein the degree of similarity is evaluated by measuring at least one degree among a degree of appearance frequency of the search keyword in the document, a degree of proximity between the search keywords, and a degree of word order between the search keywords.

In some embodiments of the present invention, a method of providing a general document search service by applying degree of similarity includes: (a) receiving at least one search keyword from a user of the service; (b) searching a general document previously stored in a database, by the search keyword; (c) evaluating a degree of similarity to the search keyword on the general document that is searched by the search keyword, wherein the degree of similarity is evaluated by measuring at least one degree among a degree of appearance frequency of the search keyword in the document, a degree of proximity between the search keywords, and a degree of word order between the search keywords; and (d) arranging the general document according to an order of one degree among the degree of appearance frequency, the degree of proximity, the degree of word order and the degree of similarity.

In some embodiments of the present invention, a system for providing a document search service by applying degree of similarity includes a keyword input unit configured to receive at least one search keyword from a user of the service; a database unit configured to store document data of the document; a document search unit configured to search the document previously stored in the database unit, by the search keyword; and a similarity evaluation unit configured to evaluate a degree of similarity to the search keyword on the document that is searched by the document search unit, wherein the degree of similarity is evaluated by measuring at least one degree among a degree of appearance frequency of the search keyword in the document, a degree of proximity between the search keywords, and a degree of word order between the search keywords.

In some embodiments of the present invention, a processor for providing a document search service by applying degree of similarity includes a recording medium capable of mechanical reading; and a program code stored in the recording medium and capable of mechanical reading, wherein the program code includes: (a) receiving at least one search keyword from a user of the service; (b) searching a document previously stored in a database, by the search keyword; and (c) evaluating a degree of similarity to the search keyword on the document that is searched by the search keyword, wherein the degree of similarity is evaluated by measuring at least one degree among a degree of appearance frequency of the search keyword in the document, a degree of proximity between the search keywords, and a degree of word order between the search keywords.

### ADVANTAGEOUS EFFECTS

According to a method for searching patent documents by applying degree of similarity and a system thereof, searching patent documents more quickly and easily is possible by arranging the patent documents according to a degree of similarity to a search keyword, and not according to whether the keyword is included in the patent documents or not.

In addition, more accurate and reliable evaluation of the degree of similarity may be possible by applying various detailed weights, such as appearance frequency, proximity and word order of a search keyword. Also users may setup and edit the weights in person, and thus user-centered search services based on a user's desired level of convenience and tastes may be provided.

In addition, a search formula may be configured by using a keyword list that has been previously stored or by using icons, and thus users may search documents more quickly and easily.

### BRIEF DESCRIPTION OF THE DRAWINGS

The above and other advantages of the present invention will become more apparent by describing in detail example embodiments thereof with reference to the accompanying drawings, in which:

FIG. 1 is a screen view illustrating search results from a conventional patent search service site (http://www.kipris.or.kr);

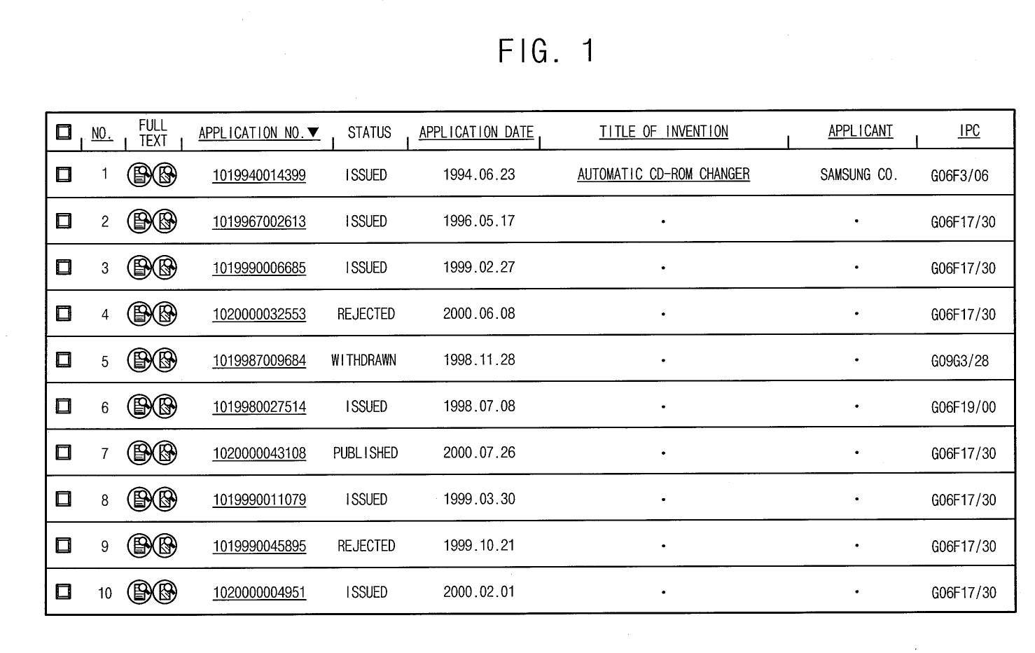

FIG. 2 is a screen view illustrating search results from a conventional patent search service site (http://www.wips.co.kr);

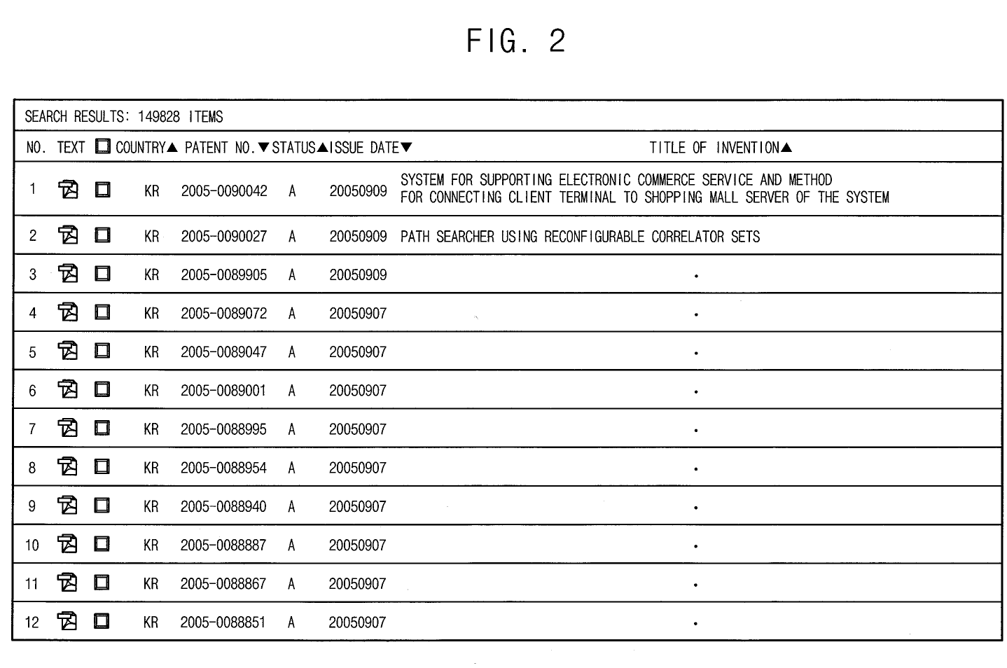

FIG. 3 is a flow chart illustrating a process of searching patent documents by applying degree of similarity according to an example embodiment of the present invention;

FIG. 4 is a screen view illustrating a screen provided to a user during a process of setting up weights applied to a degree of appearance frequency according to an example embodiment of the present invention;

FIG. 5 is a screen view illustrating a screen provided to a user during a process of setting up weights applied to a degree of proximity according to an example embodiment of the present invention;

FIG. 6 is a screen view illustrating a screen provided to a user during a process of setting up weights applied to a degree of word order according to an example embodiment of the present invention;

FIG. 7 is a screen view illustrating a screen provided to a user during a process of setting up mutual weights applied to a degree of similarity according to an example embodiment of the present invention;

FIG. 8 is a screen view illustrating an arrangement of searched documents according to the number of appeared keywords as a result of a similarity evaluation according to an example embodiment of the present invention;

FIG. 9 is a screen view illustrating an arrangement of searched documents according to a keyword order as a result of a similarity evaluation according to an example embodiment of the present invention;

FIG. 10 is a screen view illustrating detailed information of searched documents after a similarity evaluation according to an example embodiment of the present invention;

FIG. 11 is a screen view illustrating a screen provided to a user during a process of inputting search keywords according to an example embodiment of the present invention; and

FIG. 12 is a block diagram illustrating a system for providing a document search service by applying degree of similarity according to an example embodiment of the present invention.

### BEST MODE FOR CARRYING OUT THE INVENTION

It should be understood that the example embodiments of the present invention described below may be variously modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the present invention will be described in detail with reference to the accompanying drawings.

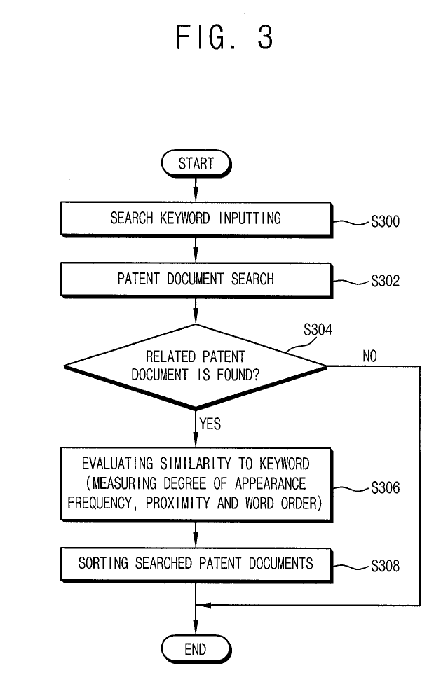

FIG. 3 is a flow chart illustrating a process of searching patent documents by applying degree of similarity according to an example embodiment of the present invention.

When a user of a search service for patent documents inputs a search keyword relating to the required previous patent (step S300), patent documents that have been previously stored in a database are searched by using the input search keyword (step S302).

The user may input more than one search keyword. In addition, the user may input combination of a plurality of search keywords.

As in a general search engine, an information data pool related to patent documents may have to be stored in the database beforehand. In one example embodiment of the present invention, the user may use stored data, the patent document files of which are stored as an MDB file type. For example, in “www.wips.co.kr,” when a user searches patent documents with a search keyword first, the user may store the searched patent documents as an MDB file type, and thus the stored MDB files may be a basis of the database related to the patent documents. That is, much of the patent document data that is searched and stored as an MDB file type through “www.wips.co.kr” may be included in the database of the patent documents according to the present invention.

After checking the database of the patent documents for whether patent documents including the search keyword or synonym of the search keyword exist or not (step S304), when patent documents relating the search keyword are found, an evaluation of a degree of similarity is performed on the found patent documents (step S306).

That is, it is evaluated as to how much of a similar correlation with the search keyword the patent documents that are searched by the search keyword have. An evaluation standard of the degree of similarity may include various types, and a more detailed description will follow.

After evaluating the degree of similarity, the searched patent documents are sorted and displayed for the user (step S308).

When the searched patent documents are sorted in order of high degree of similarity, the user may be able to grasp the contents of the searched patent documents starting from the most similar patent document quickly and easily.

The step of evaluating the degree of similarity (step S306) according to an example embodiment of the present invention may be performed by measuring degrees of “appearance frequency,” “proximity” and “word order.”

First, the degree of “appearance frequency” is described below. The degree of “appearance frequency” indicates a degree as to how many search keywords are found in the searched patent documents. Thus, the degree of similarity between the search keyword and the searched patent documents may be evaluated by measuring the appearance frequency. Therefore, the more the search keywords appear in the searched patent document, the higher the degree of similarity of the patent document may be evaluated to be. That is because the degree of “appearance frequency” may be a statistical index indicating that the patent document has more related contents and similarity, as many of the search keywords appear in the patent document.

In addition, according to an example embodiment of the present invention, not only the number of appearances but also additional conditions may be added to measuring of the degree of “appearance frequency,” and thus a more detailed and reliable evaluation of the degree of similarity is possible.

That is, according to an example embodiment of the present invention, for example, a “keyword weight,” a “part weight,” a “weight of number of sentences,” etc. may be applied to the “appearance frequency,” and more detailed descriptions will follow.

The “keyword weight” is a weight of the search keyword itself that is input by the user, and reflects relative priority to the other search keywords. That is, when the user inputs more than two search keywords, since the priority as a keyword in a document search may be different between the input search keywords, the “keyword weight” is applied to each of the search keywords. That is, although each of the search keywords appears equally, for example, ten times in one document, the priority of the keyword is relatively different depending on the keyword is a superordinate concept or a subordinate concept, a general noun, etc. The more keywords having a relatively high keyword weight appear, the higher the degree of “appearance frequency” of the patent document may be evaluated to be.

The “part weight” indicates that the priority is applied differently depending on which part of the patent document the search keywords are found. According to an example embodiment of the present invention, the patent document search is performed on, for example, three parts of the patent document, i.e., a title of invention, an abstract and an exemplary claim. Accordingly, this type of search is performed because the priority may be different depending on which part of the patent document the search keywords are found, although the search keywords are found in the same patent document. For example, although the search keywords appear equally, the similarity in a case where the search keyword is found in a part of the title of the invention may be evaluated to be higher than that in a case where the search keyword is found in a part of the abstract. Thus, the more keywords are found in the part having a higher “part weight,” the higher the degree of “appearance frequency” of the patent document may be evaluated to be.

The “weight of number of sentences” indicates in how many sentences the keywords are found with respect to the number of sentences of the searched document. An amount of content of the searched document may be large or small, for example, depending on the technical field or topic. Thus, although the same number of keywords appear, the shorter the length of the document, the higher the weight of the keyword may be estimated to be. According to an example embodiment of the present invention, the amount of the content of the document is evaluated with the number of total sentences. That is, how often the search keyword appears in every sentence is measured so that the “weight of number of sentences” may be evaluated. For example, when a document in which a keyword appears once in three sentences and a document in which a keyword appears once in five sentences are found, even though the same number of keywords appear in each of the documents, it is evaluated that the document in which keywords appear once in three sentences has a higher “weight of number of sentences”, as well as a higher weight of “appearance frequency”.

As described above, when the additional weight condition, i.e., a “keyword weight,” a “part weight,” a “weight of number of sentences,” etc. is applied to the “appearance frequency” of the search keyword, the degree of “appearance frequency” may be evaluated more elaborately and reliably.

Weight setup values of the above additional weight conditions that are used for measuring the degree of “appearance frequency” may be set up, canceled and changed according to a user's desired level of convenience. That is, the user may determine each of the relative weight values of a “keyword weight,” a “part weight” and a “weight of number of sentences,” according to each of the keywords, each of the parts and a reference number of sentences, respectively.

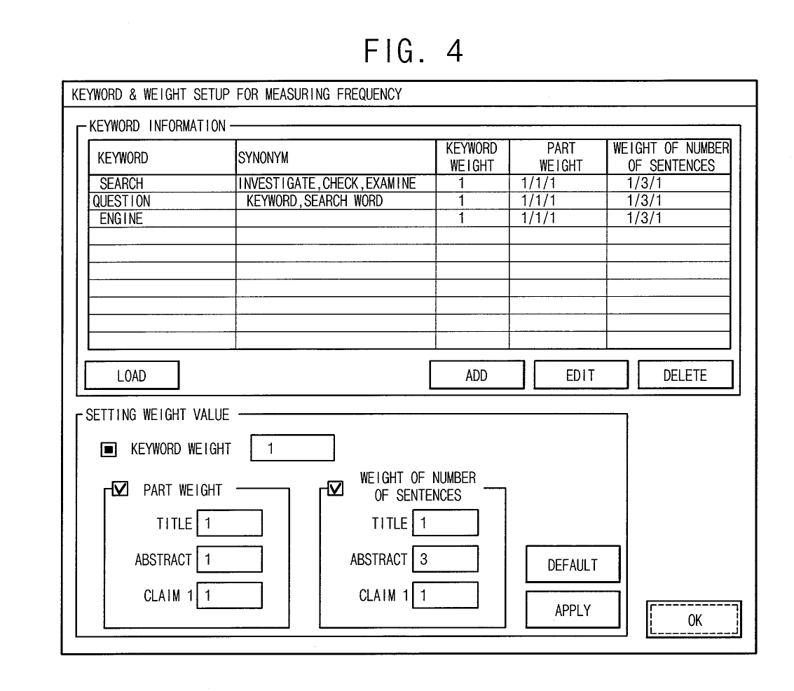

FIG. 4 is a screen view illustrating a screen provided to the user during a process of setting up weights applied to the degree of appearance frequency in a patent document search service according to an example embodiment of the present invention.

For example, when the user inputs keywords or synonyms, i.e., “search,” “question” and “engine” as search keywords, the user may set up, change or cancel the weight values of the a “keyword weight,” a “part weight” and a “weight of number of sentences” with respect to each of the keywords.

In addition, it may be possible for the user to store/load or edit the data of the keywords, weight setup values, etc. that are used in measuring the degree of “appearance frequency.”

Second, the step of evaluating the degree of similarity (step S306) according to an example embodiment of the present invention may be performed by measuring the degree of “proximity.”

The degree of “proximity” is applied in a case where more than two search keywords are input, and indicates a degree as to how close each of the keywords exists in the searched patent documents. That is, the closer the search keywords exist to each other in the searched patent document, the higher the correlation between the document and the keyword may be evaluated to be.

A more detailed and reliable evaluation of the degree of similarity is possible by adding additional conditions to the measuring of the degree of “proximity.” That is, according to an example embodiment of the present invention, for example, “keyword pair weight,” “proximity weight,” etc. may be applied to the degree of “proximity.”

The “keyword pair weight” is a keyword pair weight itself, of which the keyword pair is composed by more than two search keywords among the search keywords that the user inputs. That is, the user may combine the input search keywords to configure various keyword pairs, and the “keyword pair weight” reflects the relative priority of the keyword pair with respect to other keyword pairs. Thus, even though the same number of keyword pairs are found, the more keyword pairs having a high “keyword pair weight” are found, the higher the degree of proximity and similarity of the document are evaluated to be.

The “proximity weight” indicates how close the keywords of the keyword pair exist from each other in the document.

According to an example embodiment of the present invention, the “proximity weight” may be measured by a unit of number of sentences of the document. That is, the priority may be evaluated to be very high when the keyword pair exists in the same sentence, and the higher the distance (number of sentences) between the keywords in the keyword pair is found to be, the lower the priority may become. In addition, the priority value may be set up into levels according to a proximity distance between the keywords (for example, the same sentence through ten sentences), and according to an example embodiment of the present invention, the degree of the proximity level between the keywords of the keyword pair may be classified into six levels. That is, the “proximity weight” is 1.2, 1.0, 0.8, 0.6, 0.4 and 0.2 when the keywords composing the keyword pair are in the same sentence, one or two sentences apart, three or four sentences apart, five or six sentences apart, seven or eight sentences apart and nine or ten sentences apart, respectively.

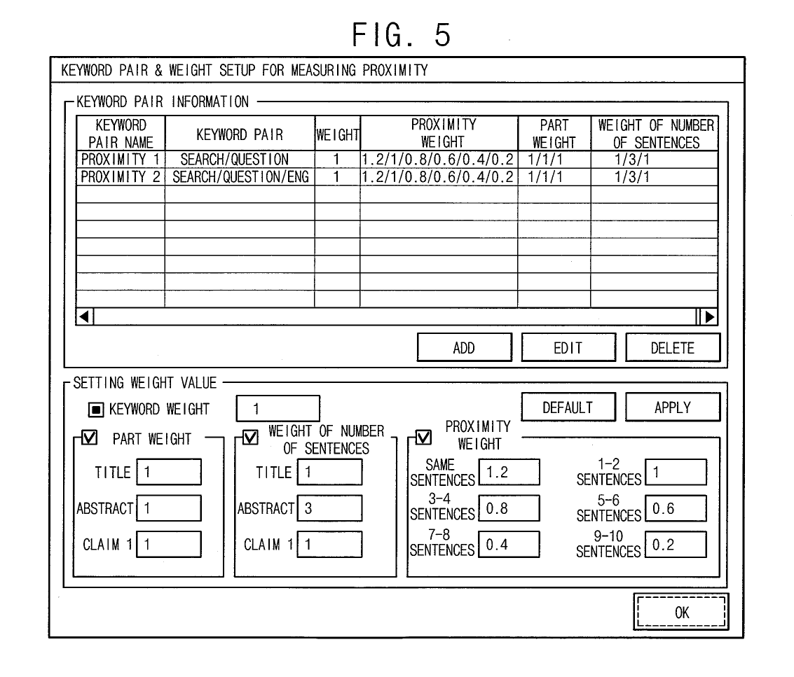

FIG. 5 is a screen view illustrating a screen provided to the user during a process of setting up weights applied to the degree of “proximity” in a patent document search service according to an example embodiment of the present invention.

When keyword pairs are configured with respect to the input keywords, the “keyword pair weight” and “proximity weight” may be set up with respect to each of the keyword pairs. That is, FIG. 5 indicates that “search” and “question” among the input keywords are combined as a keyword pair (named “proximity 1” by the user), the “keyword pair weight” is set up as “1”, and the “proximity weight” is set up into six levels as described above. Also, FIG. 5 indicates that “search,” “question” and “engine” are combined as a keyword pair (named “proximity 2” by the user), and the “keyword pair weight” and the “proximity weight” are set up similarly to “proximity 1.”

The user may set up, change or cancel not only the “keyword weight,” “part weight” and “weight of number of sentences” with respect to each of the keywords that are described in measuring the “appearance frequency,” but also the values of the “keyword pair weight” and “proximity weight” with respect to each of the keyword pairs.

In addition, it may be possible for the user to store/load or edit the data of the keyword pair, “keyword pair weight,” “proximity weight,” etc. that are used in measuring the degree of “proximity.”

Third, the step of evaluating the degree of similarity (step S306) according to an example embodiment of the present invention may be performed by measuring the degree of “word order” besides the degrees of “appearance frequency” and “proximity.”

The degree of “word order” is applied in a case where more than two search keywords are input similarly to the “proximity,” and indicates a degree as to how close each of the keywords exists according to the predetermined order in the sentence of the searched documents. For example, the more the search keywords appear by the set up order in one sentence of the searched document, the higher the correlation between the document and the keyword may be evaluated to be.

A more detailed and reliable evaluation of the degree of similarity is possible by adding additional conditions to the measuring of the degree of “word order.” That is, according to an example embodiment of the present invention, for example, a “weight of word order keyword pair,” a “weight of word order level,” etc. may be applied to the degree of “word order.”

The “weight of word order keyword pair” is a keyword pair weight itself, of which the keyword pair is composed by more than two search keywords among the search keywords that the user inputs, similarly to the “keyword pair weight” described in measuring the degree of “proximity.” That is, the user may combine the input search keywords to configure various keyword pairs, and the “weight of word order keyword pair” reflects the relative priority of the keyword pair with respect to other keyword pairs.

The “weight of word order level” indicates how close the keywords of the keyword pair exist according to the predetermined order in the sentence.

According to an example embodiment of the present invention, the “weight of word order level” may be measured by applying weights according to an order that the keywords exist, i.e., a type of word order, when the keywords of the word order keyword pair exist in one sentence of the document. That is, the priority may be evaluated to be very high when the keywords exist according to the predetermined order in the keyword pair, and the priority is low when the order is changed. That is because although the same number of keywords are found, the priority may be different depending on the combination order of the keywords existing in the document.

According to an example embodiment of the present invention, the “weight of word order level” may be classified into two levels or six levels according to the number of keywords existing in the keyword pair. That is, in a case where the number of keywords constituting the keyword pair is two, the weights may be differently applied to each case, that is, in which the keywords may exist in an (a, b) order or a reverse (b, a) order. In addition, in a case where the number of keywords constituting the keyword pair is three, the relative weights with respect to the respective type of word order may be differently applied to each case, that is, in which the keywords may exist in an (a, b, c), an (a, c, b), a (b, c, a), a (b, a, c), a (c, a, b) or a (c, b, a) type of word order.

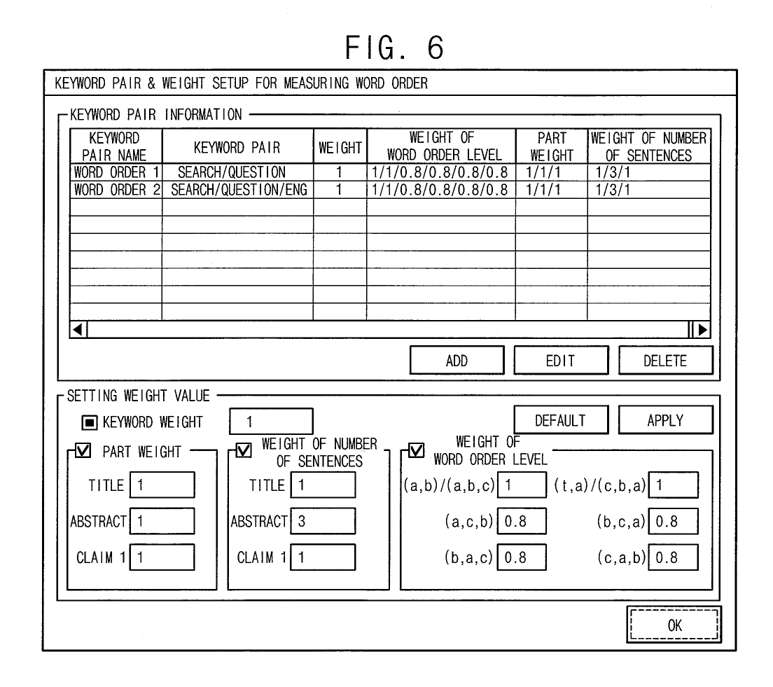

FIG. 6 is a screen view illustrating a screen provided to the user during a process of setting up weights applied to the degree of “word order” in a patent document search service according to an example embodiment of the present invention.

When keyword pairs are configured with respect to the input keywords, the “weight of word order keyword pair” and “weight of word order level” may be set up with respect to each of the keyword pairs. That is, FIG. 6 indicates that “search” and “question” among the input keywords are combined as a keyword pair (named “word order 1” by the user), and the “weight of word order keyword pair” is set up as “1” and the “weight of word order level” is set up into two levels as described above. Also, FIG. 5 indicates that “search,” “question” and “engine” are combined as a word order keyword pair (named “word order 2” by the user), and the “weight of word order keyword pair” and the “weight of word order level” are set up similarly to “word order 1.”

The user may set up, change or cancel not only the “keyword weight,” “part weight” and “weight of number of sentences” with respect to each of the keywords that are described in measuring the “appearance frequency” and “proximity,” but also the value of the “weight of word order keyword pair” and “weight of word order level” with respect to each of the keyword pairs.

In addition, it may be possible for the user to store/load or edit the data of the word order keyword pair, “weight of word order keyword pair,” “weight of word order level,” etc. that are used in measuring the degree of “word order.”

As described above, the step of evaluating the degree of similarity (step S306) according to an example embodiment of the present invention may be performed more minutely and accurately by measuring the degree of “appearance frequency,” “proximity” and “word order.”

In addition, the measuring of the degree of “appearance frequency,” “proximity” and “word order” may be set up or canceled by the user's selection. That is, the user may select and measure the items that the user intends to apply for evaluating the similarity. For example, when the user wants to evaluate the similarity by measuring only the degrees of “appearance frequency” and “proximity,” the user may set up the measuring of the degrees of “appearance frequency” and “proximity” and cancel the measuring of the degree of “word order.” In addition, when the user wants to evaluate the similarity by measuring only the degree of “word order,” the user may set up the measuring of the degree of “word order” and cancel the measuring of the degrees of “appearance frequency” and “proximity.”

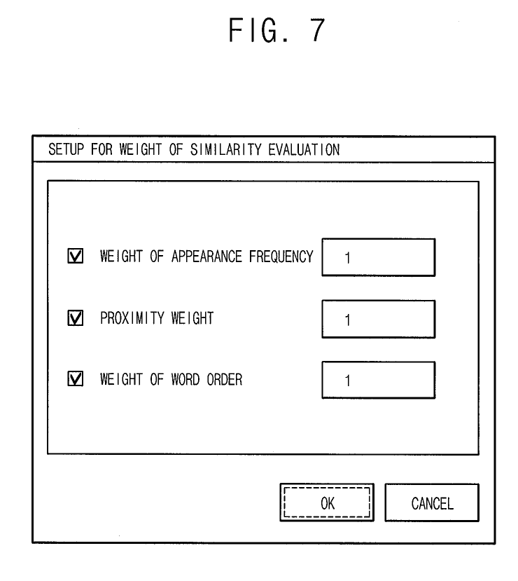

FIG. 7 is a screen view illustrating a screen provided to the user during a process of setting up mutual weights applied to the degree of similarity in a patent document search service according to an example embodiment of the present invention.

As described above, the degrees of “appearance frequency,” “proximity” and “word order” may be exemplary as the items capable of being used in the similarity evaluation of the searched document. According to an example embodiment of the present invention, a “weight of similarity evaluation” may be applied to each of the items that are applied for evaluating the degree of similarity, of which the “weight of similarity evaluation” indicates relative priority between each of the items.

That is, the “weight of similarity evaluation” is applied in a case where more than two items are applied for evaluating the degree of similarity, and mutual priority between the items that are applied for evaluating the degree of similarity may be set up as illustrated in FIG. 7, and thus a ratio between the measured values of each items may be determined, of which the ratio is reflected when ultimate similarity is evaluated. Also, the “weight of similarity evaluation” may be set up according to the user's selection. For example, the user may set up the weight of the “proximity” item to be high when the user judges that the “proximity” is more important than other items in evaluating the similarity. In addition, it may be possible for the user to store/load or edit the setup values of the “weight of similarity evaluation.”

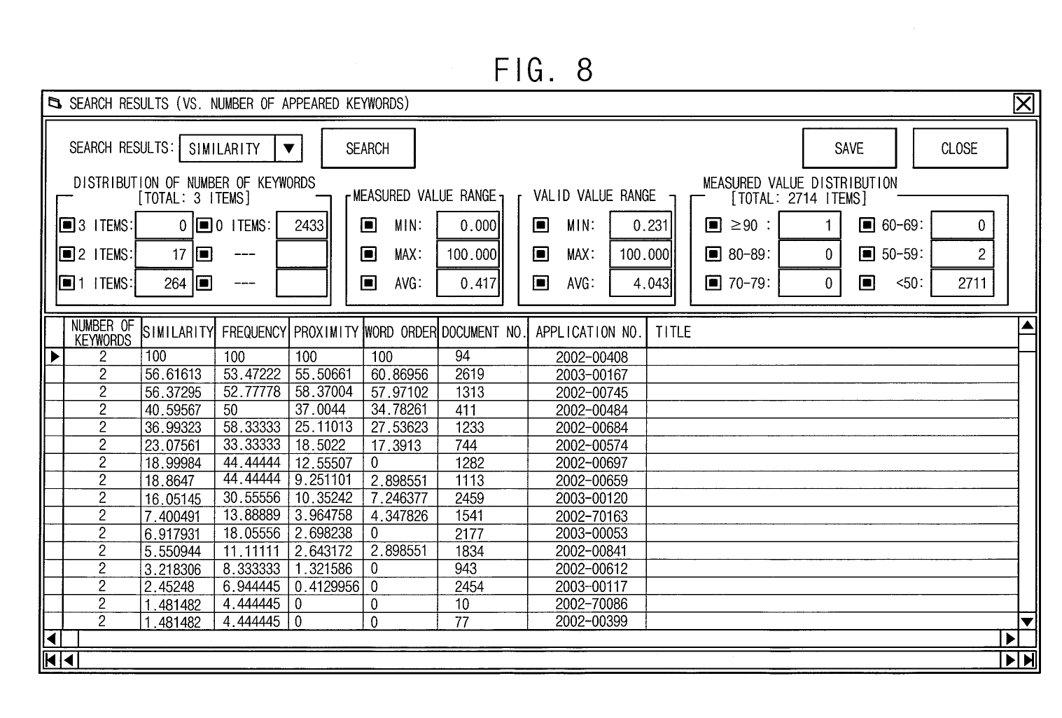

FIG. 8 is a screen view illustrating an arrangement of the searched documents according to the number of appeared keywords as a result of a similarity evaluation in a patent document search service according to an example embodiment of the present invention.

The searched documents are displayed together with evaluated values of similarity or weights that are applied for the similarity evaluation, i.e., the degrees of “appearance frequency,” “proximity” and “word order.” While FIG. 8 indicates that the searched documents are arranged in order of high similarity based on the number of appeared keywords, the user may select each item, i.e., the degree of “similarity,” “appearance frequency,” “proximity” or “word order,” and the searched documents may be arranged based on an order of the selected item.

In addition, the user may check not only the final results of the similarity evaluation, but also interim results related to interim evaluation operations that are applied for evaluating the similarity (i.e., measuring of the “appearance frequency,” “proximity,” “word order,” etc.) when each of the evaluation operations is completed. In addition, it may be possible for the user to store/load or edit the final results of the similarity evaluation.

As described above, the user may find desired documents easily and quickly by arranging the searched documents in order of the degree of similarity.

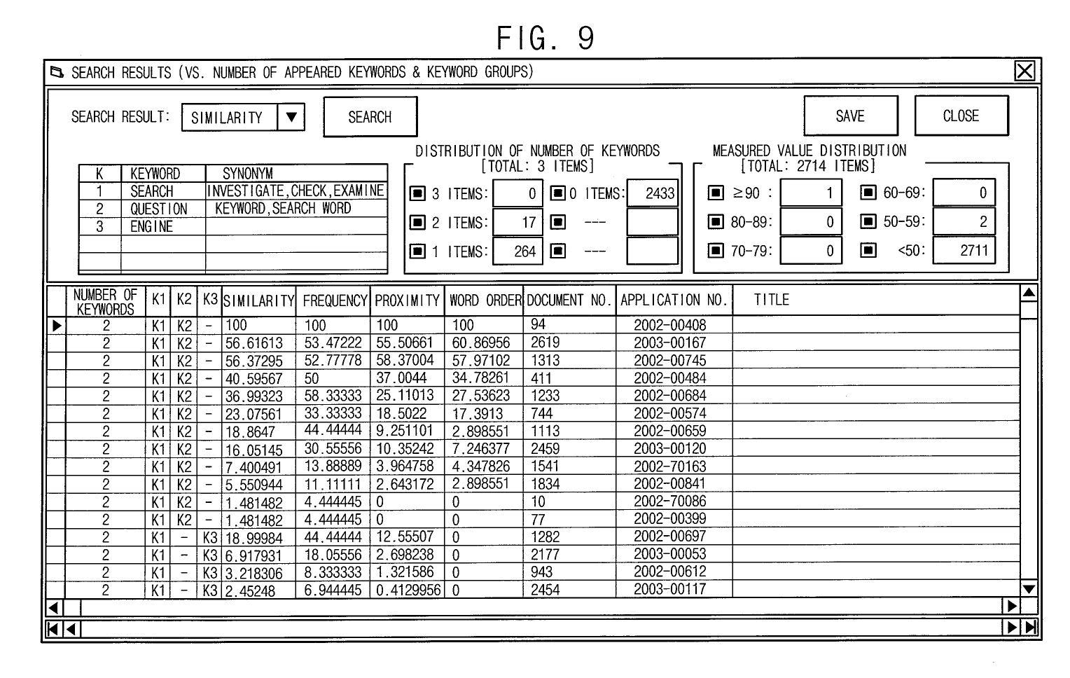

FIG. 9 is a screen view illustrating an arrangement of the searched documents according to a keyword order as a result of a similarity evaluation in a patent document search service according to an example embodiment of the present invention.

In a case where keywords are registered as K1, K2 and K3 as illustrated in FIG. 9, the searched documents may be arranged in order of high similarity based on an order that each of the keywords appear. That is, the searched documents may be arranged in order of high similarity, with respect to the documents in which the keywords appear in an order, for example, (K1, K2), (K1, K3), (K2, K3), etc.

As described above, the step of evaluating the degree of similarity of the searched documents and arranging the searched documents may be embodied in various ways.

In addition, as illustrated in FIGS. 8 and 9, identification notes are displayed for each of the documents on the screen illustrating the results of a similarity evaluation, so that the user is able to discern the contents of the searched documents. That is, the identification notes, such as title of the invention, application number, issue status, applicant, filing date, document number, etc., are displayed together with the evaluated values of the degree of “appearance frequency,” “proximity,” “word order” or “similarity,” and thus the user may be able to grasp basis facts at a glance.

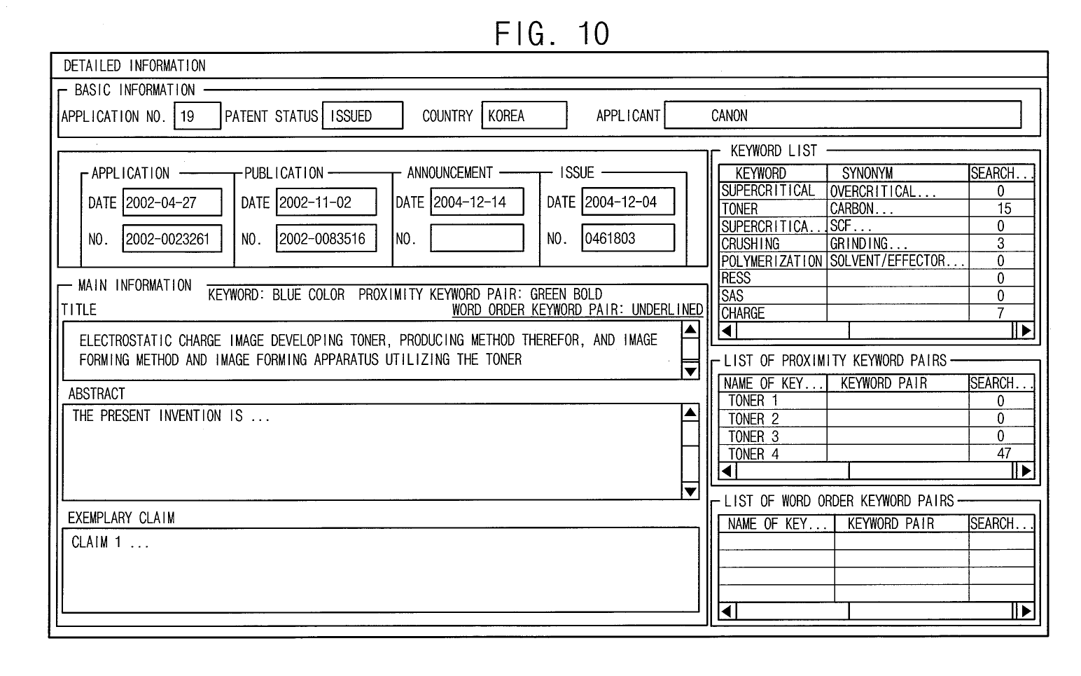

FIG. 10 is a screen view illustrating detailed information of the searched documents after a similarity evaluation in a patent document search service according to an example embodiment of the present invention.

When the results of a similarity evaluation are provided after document searching according to an example embodiment of the present invention as illustrated in FIGS. 8 and 9, the user may select a specific document so as to check more detailed information related to the desired document. For example, the user may check the desired document by selecting and double-clicking the desired document from the result list. When the document is selected, detailed contents of the selected document are displayed as illustrated in FIG. 10. In FIG. 10, information according to document number, patent status, application country, applicant, application date, application number, published date, publication number, firm information, issue date, patent number, title, abstract, exemplary claim (claim 1), etc. is displayed. Also, information according to background art, specific description, technical effect, claims, drawings, etc. may also be displayed for the user.

In addition, information related to the keyword, such as search keywords for the “appearance frequency,” word pairs for the “proximity,” word pairs for the “word order,” etc., may be displayed by colors, and the keyword list may be displayed together, thereby enhancing a user's level of convenience.

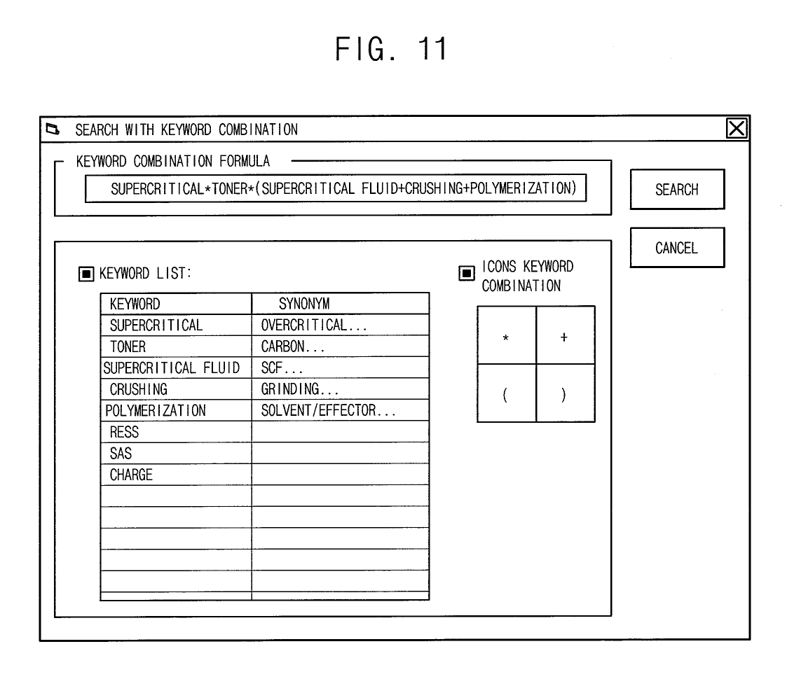

FIG. 11 is a screen view illustrating a screen provided to the user during a process of inputting search keywords in a patent document search service according to an example embodiment of the present invention.

In contrast to general search services, in a patent document search service according to an example embodiment of the present invention, the user may select keywords that the user intends to input from a keyword list that has been previously stored, and when the user inputs a plurality of keywords in combination, the user may click icons corresponding to a combination formula instead of inputting the combination formula with a keyboard one by one, thereby configuring the search combination formula more easily and quickly.

As described above, it is described that the example embodiments of the present invention may be adapted to patent documents. However, the above example embodiments of the present invention may be adapted to general documents and not be limited to patent documents. That is, since patent documents have unique characteristics different from general documents, searches for patent documents are performed differently from searches for general documents. Thus, the present invention may be applied even in searches for general documents, that include more comprehensive concepts than the patent documents, so as to achieve efficient searches by evaluating the degree of “appearance frequency,” “proximity,” “word order”, “similarity,” etc.

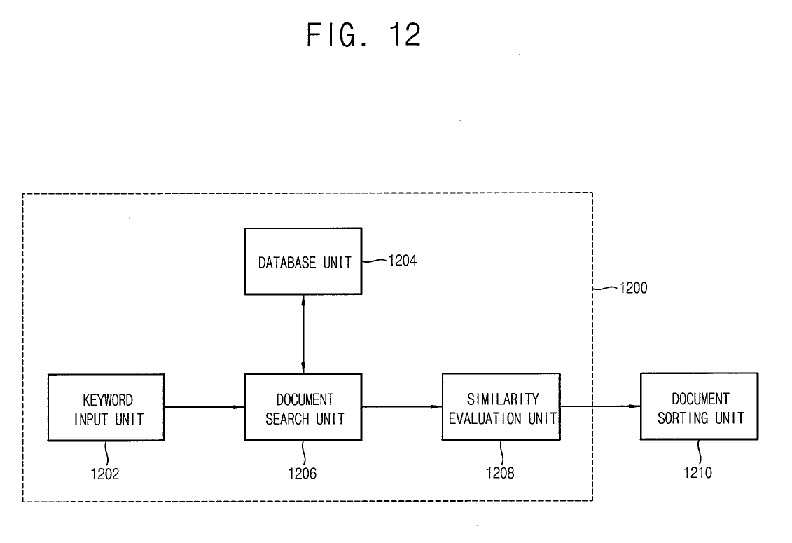

FIG. 12 is a block diagram illustrating a system for providing a document search service by applying degree of similarity according to an example embodiment of the present invention.

A system for providing a document search service by applying degree of similarity 1200 includes a keyword input unit 1202, a database unit 1204, a document search unit 1206 and a similarity evaluation unit 1208.

The keyword input unit 1202 receives at least one keyword from the search service user. The keywords that the user intends to input may be selected from a keyword list that has been previously stored, and may thereby be input to the keyword input unit 1202. In addition, when a plurality of keywords is combined, an icon that corresponds to a combination formula may be clicked to configure a search formula, and thus the search formula may be input to the keyword input unit 1202.

The database unit 1204 stores data related to documents. An information data pool related to the documents needs to be stored in the database unit 1204 in advance. According to an example embodiment of the present invention, document data that is stored as an MDB file type may be stored in the database unit 1204 as described above.

The document search unit 1206 searches documents that are stored in the database unit 1204 by using the search keyword input in the keyword input unit 1202. That is, the document search unit 1206 checks whether a document including the search keyword or a synonym of the search keyword exists in the database unit 1204.

The similarity evaluation unit 1208 evaluates the degree of similarity on the searched document from the document search unit 1206. The degree of similarity is evaluated through a measuring of the degrees of “appearance frequency,” “proximity” and “word order,” and detailed weights may be applied to the degrees of “appearance frequency,” “proximity” and “word order,” respectively, as described above. That is, as described above, at least one weight among a “keyword weight,” a “part weight” and a “weight of number of sentences” may be applied with respect to the degree of “appearance frequency,” and at least one weight among a “keyword pair weight” and a “proximity weight” may be applied with respect to the degree of “proximity,” and at least one weight among a “weight of word order keyword pair” and a “weight of word order level” may be applied with respect to the degree of “word order.” In addition, a “weight of similarity evaluation” indicating mutual weights between the degrees of “appearance frequency,” “proximity” and “word order” may be applied, and setup values of the detailed weights or “weight of similarity evaluation” may be set up according to a user's desired level of convenience.

In addition, it will be understood that the characteristics of the document search service described in FIGS. 3 through 11 may be included in the system for providing a document search service by applying degree of similarity 1200.

The document sorting unit 1210 sorts documents of which a degree of similarity is evaluated by the similarity evaluation unit 1208 according to an order of the degree of similarity. In addition, as described above, the documents may be arranged according to a user's choices based on an order of each of weight items, i.e., the degrees of “appearance frequency,” “proximity” and “word order.”

Having described the example embodiments of the present invention and its advantages, it is noted that various changes, substitutions and alterations can be made herein without departing from the spirit and scope of the invention as defined by appended claims.

### INDUSTRIAL APPLICABILITY

According to the method for searching patent documents by applying degree of similarity and a system thereof, users may be able to search huge patent documents more quickly and easily, so that effective use of the patent documents in technical development may be possible and material may be provided for quick evaluation as to whether an intellectual property right is valid or not in a patent dispute.

1. A method of providing a patent document search service by applying degree of similarity, comprising:
(a) receiving at least one search keyword from a user of the service;
(b) searching a patent document previously stored in a database, by the search keyword; and
(c) evaluating a degree of similarity to the search keyword on the patent document that is searched by the search keyword, wherein the degree of similarity is evaluated by measuring at least one degree among a degree of appearance frequency of the search keyword in the document, a degree of proximity between the search keywords, and a degree of word order between the search keywords.

2. The method of claim 1, wherein the degree of appearance frequency is measured by applying an additional weight to the degree of appearance frequency.

3. The method of claim 2, wherein the additional weight includes at least one weight among a keyword weight with respect to the search keyword itself, a part weight with respect to the patent document, and a weight of number of sentences with respect to a number of sentences in which the search keyword is found.

4. The method of claim 3, wherein the part weight is with respect to at least two parts among a title of invention, an abstract and an exemplary claim.

5. The method of claim 2, wherein a setup value of the additional weight is set up according to the user's selections.

6. The method of claim 1, wherein the degree of proximity is measured by applying at least one weight among a keyword pair weight and a proximity weight, the keyword pair weight indicating a mutual weight between keyword pairs configured with the search keywords, and the proximity weight indicating a degree of proximity between each of the keywords of the keyword pair.

7. The method of claim 6, wherein the proximity weight is applied by measuring the degree of proximity by a unit of sentence of the patent document.

8. The method of claim 6, wherein setup values of the keyword pair weight and the proximity weight are set up according to the user's selections.

9. The method of claim 1, wherein the degree of word order is measured by applying at least one weight among a weight of word order keyword pair and a weight of word order level, the weight of word order keyword pair indicating a mutual weight between keyword pairs configured with the search keywords, and the weight of word order level being based on a word order type between each of the keywords of the keyword pair.

10. The method of claim 9, wherein setup values of the weight of word order keyword pair and the weight of word order level are set up according to the user's selections.

11. The method of claim 1, wherein measuring of the degree of appearance frequency, the degree of proximity and the degree of word order is set up or canceled according to the user's selections.

12. The method of claim 1, wherein the degree of similarity is evaluated by applying a weight of similarity evaluation indicating a mutual weight between the degree of appearance frequency, the degree of proximity and the degree of word order.

13. The method of claim 12, wherein a setup value of the weight of similarity evaluation is set up according to the user's selections.

14. The method of claim 1, wherein the search keyword includes a synonym of the search keyword.

15. The method of claim 1, wherein in the step of (a), the search keyword is input as a combination of the search keyword, and a combination formula for the combination of the search keyword is displayed as an icon to the user and the icon is set up according to the user's selections.

16. (canceled)

17. The method of claim 1, wherein in the step of (c), evaluation results related to the degree of similarity or data used in evaluating of the degree of similarity are stored, loaded and edited according to the user's selections.

18. The method of claim 17, wherein the data used in evaluating of the degree of similarity includes the search keyword, a keyword pair configured with the search keywords and information related to a weight applied in evaluating of the degree of similarity.

19. The method of claim 1, further comprising:
(d) arranging the patent document according to an order of one degree among the degree of appearance frequency, the degree of proximity, the degree of word order and the degree of similarity.

20. The method of claim 19, wherein in the step of (d), the patent document is arranged together with an identification note or at least one evaluation value of the degree of appearance frequency, the degree of proximity, the degree of word order and the degree of similarity, the identification note allowing the user to discern the contents of the patent document.

21. The method of claim 20, wherein the identification note includes at least one among a title of invention, an application number, an application date, an issue status and an applicant.

22. The method of claim 19, further comprising:
(e) providing detailed information of the arranged patent document, according to the user's selections.

23. The method of claim 22, wherein the detailed information includes at least one among a title of invention, an abstract, a specific description, an exemplary claim and a drawing.

24. (canceled)

25. (canceled)

26. (canceled)

27. (canceled)

28. (canceled)

29. (canceled)

30. A system for providing a document search service by applying degree of similarity, comprising:
a keyword input unit configured to receive at least one search keyword from a user of the service;
a database unit configured to store document data of the document;
a document search unit configured to search the document previously stored in the database unit, by the search keyword; and
a similarity evaluation unit configured to evaluate a degree of similarity to the search keyword on the document that is searched by the document search unit, wherein the degree of similarity is evaluated by measuring at least one degree among a degree of appearance frequency of the search keyword in the document, a degree of proximity between the search keywords, and a degree of word order between the search keywords.

31. The system of claim 30, wherein the keyword input unit is configured to receive the search keyword as a combination of the search keyword, and a combination formula for the combination of the search keyword is displayed as an icon to the user and the icon is set up according to the user's selections.

32. The system of claim 30, wherein the similarity evaluation unit is configured to evaluate the degree of similarity by applying a detailed weight with respect to at least one degree among the degree of appearance frequency, the degree of proximity and the degree of word order.

33. The system of claim 32, wherein the detailed weight is at least one weight among a keyword weight, a part weight and a weight of number of sentences, with respect to the degree of appearance frequency,
at least one weight among a keyword pair weight and a proximity weight, with respect to the degree of proximity, and
at least one weight among a weight of word order keyword pair and a weight of word order level, with respect to the degree of word order.

34. The system of claim 32, wherein a setup value of the detailed weight is set up according to the user's selections.

35. The system of claim 30, wherein the similarity evaluation unit is configured to evaluate the degree of similarity by applying a weight of similarity evaluation indicating a mutual weight between the degree of appearance frequency, the degree of proximity and the degree of word order.

36. The system of claim 35, wherein a setup value of the weight of similarity evaluation is set up according to the user's selections.

37. A processor for providing a document search service by applying degree of similarity, comprising:
a recording medium capable of mechanical reading; and
a program code stored in the recording medium and capable of mechanical reading,
wherein the program code includes a process comprising:
(a) receiving at least one search keyword from a user of the service;
(b) searching a document previously stored in a database, by the search keyword; and
(c) evaluating a degree of similarity to the search keyword on the document that is searched by the search keyword, wherein the degree of similarity is evaluated by measuring at least one degree among a degree of appearance frequency of the search keyword in the document, a degree of proximity between the search keywords, and a degree of word order between the search keywords.
